(19) United States
(12) Patent Application Publication
(10) Pub. No.: US 2011/0308095 A1
(43) Pub. Date: Dec. 22, 2011

(54) PORTABLE CUTTING MACHINE

(75) Inventors: Kazunobu Yoshimura, Tokyo (JP); Tomofumi Ichiba, Tokyo (JP); Takuma Nonaka, Tokyo (JP); Atsuhito Okada, Hiroshima (JP)

(73) Assignees: RYOBI LTD., Fuchu-shi (JP); MAX CO., LTD., Tokyo (JP)

(21) Appl. No.: 13/203,533

(22) PCT Filed: Mar. 5, 2010
(86) PCT No.: PCT/JP2010/053691

§ 371 Date: Aug. 26, 2011

(30) Foreign Application Priority Data
Mar. 5, 2009 (JP) 2009-052600

(51) Int. Cl. B23D 47/00; B23D 45/16

(52) U.S. Cl. 30/377

(57) ABSTRACT

A portable cutting machine is provided with: a cutting machine main body (3); a saw blade (1) provided rotatably with respect to the cutting machine main body (3); an electric motor (2) adapted to drive the saw blade (1); a handle (4) which is provided between the saw blade (1) and the electric motor (2) in a first direction parallel to a rotation shaft (9) of the saw blade (1) and extends in a second direction perpendicular to the first direction; a battery pack (5) adapted to drive the electric motor (2); and a surface plate (6) rotatably supported by the cutting machine main body (3). A center in the first direction of the battery pack (5) is located closer to a side of the electric motor (2) than a center in the first direction of the handle (4). The rotation shaft (9) of the saw blade (1) is located on one side of the surface plate (6). A part of the saw blade (1) passes through an opening portion (16) penetrating through the surface plate (6) and is exposed to the other side of the surface plate (6). A projecting amount of the saw blade (1) by which the part of the saw blade (1) projects from the other side of the surface plate (6) is changeable by changing an angle of the surface plate (6) with respect to the cutting machine main body (3). A cutting-depth adjusting mechanism adapted to change the angle of the surface plate (6) with respect to the cutting machine main body (3) is located, in the first direction, closer to a side of the saw blade (1) than the battery pack (5).

### TECHNICAL FIELD

The present invention relates to a portable cutting machine driven by a battery.

### BACKGROUND ART

It has been a mainstream to use a home commercial power supply for this type of portable cutting machine. However, in such the portable cutting machine, there are problems that a power cable tags along thereby to cause bad handling of the cable, and utilization is not permitted when there is no power supply close. Therefore, recently, a machine provided with a battery pack which can be detachably attached as a power supply has been offered in markets (refer to Patent Documents 1, 2, and 3).

### PRIOR ART DOCUMENT

### Patent Document

Patent Document 1: JP-2008-018498-A

Patent Document 2: JP-2001-293672-A

Patent Document 3: JP-2002-316302-A

In such the portable cutting machine, a saw blade, a saw cover for covering the saw blade, and an electric motor for driving the saw blade are provided in a cutting machine main body by side in right-left direction. On top of the cutting machine main body, an operation handle is arranged in a front-back direction. At a back lower portion of the handle, a battery pack is provided detachably. However, the battery pack, as well as the electric motor, the saw blade, and the saw cover, is a weighty part in the portable cutting machine components. Therefore, it is not preferable on weight balance to provide the battery pack in a position apart from an operational part (trigger lever) of the handle. The operational part of the handle is provided at a front portion of a handle grip portion so as to be able to be operated by an index finger. Therefore, compared with a machine in which a battery, an electric motor, and a saw blade (including a saw cover) are provided in positions close to the operational part of the handle, a machine in which their three parts are provided in positions apart from the operational part of the handle becomes long in the front-back direction even if it has the same weight as the compared machine. Accordingly, in case that an operator cuts members near his both sides in turn, it is difficult to move the cutting machine briskly with it in his hand. Therefore, it is preferable that the battery, the electric motor, and the saw blade are concentrated in positions close to the operational part of the handle.

In this sense, currently, in the cutting machine described in the Patent Document 1, the battery and the handle operating part are closest to each other. Therefore, it will be said that this concentrated structure is making the biggest progress.

However, even the cutting machine in the Patent Document 1 is not necessarily satisfied in a point of good handling. It is because the battery pack cannot be brought close to the electric motor side due to existence of a cutting-depth adjusting mechanism in the cutting machine. Namely, at the back portion of the cutting machine main body, the cutting-depth adjusting mechanism is provided. This adjusting mechanism is used to adjust inclination of a surface plate arranged rotatably at the lower portion of the cutting machine main body thereby to adjust the projecting amount of the saw blade exposed from the undersurface of the surface plate. A mechanism body is arranged on the saw blade side, an adjusting lever for adjusting the projecting amount of the saw blade is arranged on the electric motor side which is the opposite side to the saw blade side, and the mechanism body and the adjusting lever are connected to each other by a shaft. In the above structure, since the shaft cannot help being provided between the battery pack and the electric motor, the battery pack cannot be brought closer to the electric motor than the battery pack in the structure described in the Patent Document. If the shaft is shorten and arrange of the adjusting lever is moved to the saw blade side, the battery pack can be brought close to the electric motor side (front side). However, in this case, space for attaching the adjusting lever is lost. Therefore, it will be said that it is impossible in the present situation to modify the arrangement described in the Patent Document 1.

### SUMMARY OF INVENTION

One or more embodiments of the invention provide a portable cutting machine which enhances more concentration of to arrangements of a battery, an electric motor, and a saw blade, and which is small in size, good in weight balance and easy in handling.

According to the embodiments of the invention, a portable cutting machine is provided with: a cutting machine main body (3); a saw blade (1) provided rotatably with respect to the cutting machine main body (3); an electric motor (2) which drives the saw blade (1); a handle (4) which is provided between the saw blade (1) and the electric motor (2) in a first direction parallel to a rotation shaft (9) of the saw blade (1), and extends in a second direction perpendicular to the first direction; a battery pack (5) for driving the electric motor (2); and a surface plate (6) supported rotatably by the cutting machine main body (3). The center in the first direction of the battery pack (5) is located nearer the electric motor (2) side than the center in the first direction of the handle (4). The rotation shaft (9) of the saw blade (1) is located on one side of the surface plate (6). A part of the saw blade (1) passes through an opening portion (16) extending through the surface plate (6), and is exposed to the other side of the surface plate (6). By changing an angle of the surface plate (6) in relation to the cutting machine main body (3), the projecting amount by which a part of the saw blade (1) projects from the other side of the surface plate (6) is changed. A cutting-depth adjusting mechanism for changing the angle of the surface plate (6) with the cutting machine main body (3) is located, in the first direction, closer to the saw blade (1) side than to the battery pack (5).

According to the portable cutting machine having the above structure, since the battery pack is provided in the vicinity of the electric motor and in a position off-set from the center of the handle to the electric motor side, space can be formed between a saw cover for coving the saw blade and the battery pack, and this space can be utilized as space in which the cutting-depth adjusting mechanism is provided. In case that the cutting-depth cutting mechanism is arranged closer to the saw blade than to the battery pack, there is not any obstacle to arranging the battery pack close to the back portion of the electric motor. Therefore, the battery pack can be arranged in such a close position that the battery pack can abut directly on an electric motor housing. Further, since the battery pack, the electric motor, and the saw blade (including a saw cover) are arranged in a concentrated manner near an operational part provided at the front portion of the handle, size reduction of the machine can be advanced more.

Not only the battery pack, the electric motor, and the saw blade are arranged in the concentrated manner, but also the battery pack is provided near the electric motor and in the position off-set from the center of the handle to the electric motor side. Hereby, since right-left balance in weight is good when an operator holds the portable cutting machine in his hand, and the portable cutting machine is stable without tilting neither to the left nor to the right, the portable cutting machine is good in handling and the operator is difficult to get tired even if he uses the portable cutting machine for a long time. Therefore, it is possible to obtain a portable cutting machine which is good in weight balance, and greatly easy for handling.

In the above structure, the cutting-depth adjusting mechanism may include a link (21) which protrudes from a surface on one side of the surface plate (6), holding bodies (22), (23) provided on the cutting machine main body (3), and an adjusting lever (27) for changing a relative position between the holding bodies (22) , (23) and the link (21). According to this constitution, when the holding bodies (22), (23) are separated from the link (21) by the operation of the adjusting lever (27), the surface plate (6) becomes rotatable in relation to the cutting machine main body (3) integrally with the link (21), so that the projecting amount by which a part of the saw blade (1) projects from the other side of the surface plate (6) can be changed. When the holding bodies (22), (23) are engaged with the link (21) by the operation of the adjusting lever (27), the surface plate (6) becomes unrotatable in relation to the cutting machine main body (3) integrally with the link (21), so that the projecting amount by which a part of the saw blade (1) projects from the other side of the surface plate (6) can be fixed.

The portable cutting machine having the above structure may further include a saw cover (14) which is fixed to the cutting machine main body (3) and covers the saw blade (1) portion located on one side of the surface plate (6). Further, the adjusting lever (27) may be arranged between the battery pack (5) and the saw blade (1) and have a shape turning to a backside of the saw caver (14).

According to the portable cutting machine having the above structure, since the adjusting lever of the cutting-depth adjusting mechanism is arranged between the battery pack and the saw blade, the adjusting lever can be arranged in the back position of the cutting machine main body almost similarly to the conventional adjusting lever. Therefore, without operator's confusion, operability is not damaged. Further, since an accident that the adjusting lever bumps against other members during the cutting operation becomes difficult to occur, malfunction of the cutting-depth adjusting mechanism is hardly produced, so that safety of the work is improved. Further, since the adjusting lever is formed in the turning shape to the backside of the saw cover, the operability is improved.

### BRIEF DESCRIPTION OF DRAWINGS

FIG. 1 is a side view of a portable cutting machine according to an exemplary embodiment of the invention.

FIG. 2 is a plane view of the portable cutting machine of FIG. 1

FIG. 3 is a sectional view taken along a line a-a in FIG. 1.

FIG. 4 is a sectional view taken along a line b-b in FIG. 2.

FIG. 5 is a sectional view taken along a line c-c in FIG. 2.

FIG. 6 is a sectional view taken along a line d-d in FIG. 2.

FIG. 7 is a diagram for explaining an operation mode of a cutting-depth adjusting mechanism in section taken along the line d-d in FIG. 2.

### DESCRIPTION OF EMBODIMENTS

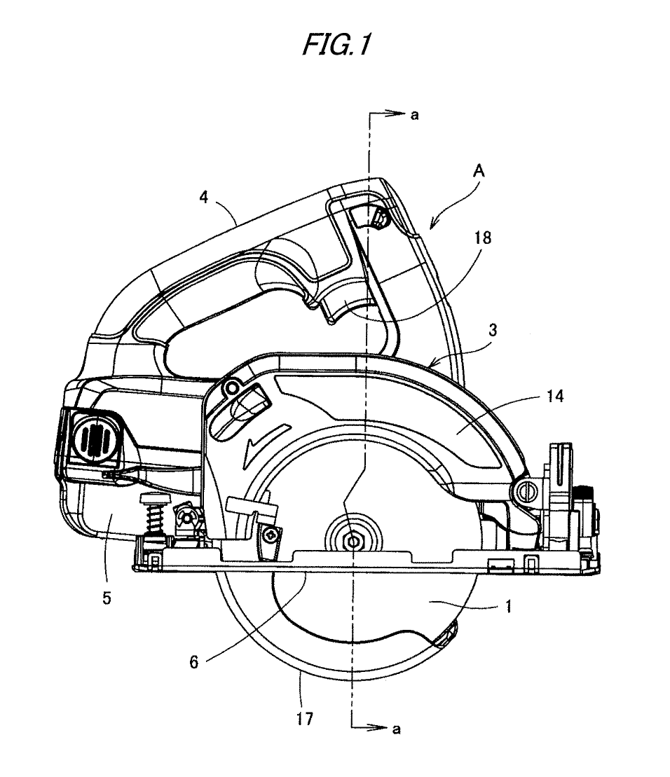

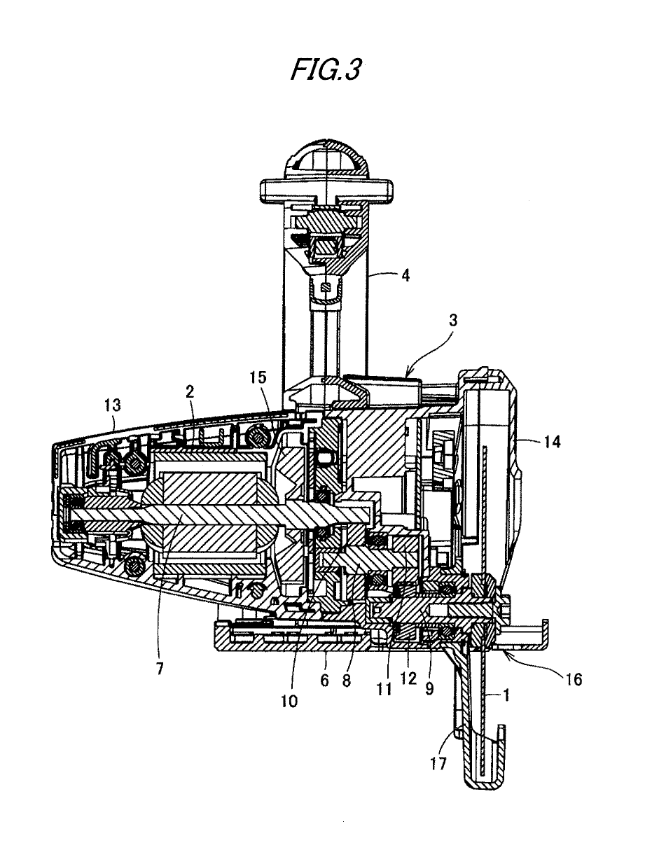

In FIGS. 1 to 3, a reference character “A” represents a portable cutting machine according to an exemplary embodiment of the invention. In the cutting machine, a saw blade (circular saw) 1 and an electric motor 2 for driving this saw blade 1 are provided on a cutting machine main body 3 side by side in the right-left direction. The saw blade 1 is rotatably provided on the cutting machine main body 3. On top of the cutting machine main body 3, a handle 4 for operation is arranged in parallel to a cutting direction of the saw blade 1, that is, in a front-back direction. Namely, the handle 4 is provided, in a first direction parallel to a rotation shaft 9 of the saw blade 1, between the saw blade 1 and the electric motor 2, and extends in a second direction perpendicular to the first direction. To a lower portion of a rear end 4a of the above handle 4, a battery pack 5 for driving the electric motor 2 is provided detachably. At the bottom of the cutting machine main body 3, there is provided a surface plate 6 to be placed on a material to be cut. For the cutting machine main body 3 and the surface plate 6, there is provided a cutting-depth adjusting mechanism (described later) which adjusts the prof ecting amount of the saw blade 1 exposed from the undersurface of the surface plate 6.

A first reduction gear 10 fixed to one end of an intermediate shaft 8 meshes with an output shaft 7 of the electric motor 2, and further a second reduction gear 11 fixed to the other end of the intermediate shaft 8 meshes with a third reduction gear 12 fixed to a final shaft 9. To the final shaft 9, the saw blade 1 is fixed. Hereby, as the electric motor 2 rotates, its rotational force is transmitted through the first, second, and third reduction gears 10, 11, and 12, to the final shaft 9, and then the saw blade 1 rotates. Namely, the final shaft 9 functions as a rotation shaft of the saw blade 1.

The electric motor 2 is attached into a motor housing 13. A substantially half-round portion of the saw blade 1 above the surface plate 6 is covered with a saw cover 14 for securing safety (saw cover 14 which is fixed to the cutting machine main body 3, and covers the saw blade 1 portion located on one side (upper side) of the surface plate 6). To the output shaft 7 of the electric motor 2, a fan 15 for cooling the electric motor is also attached.

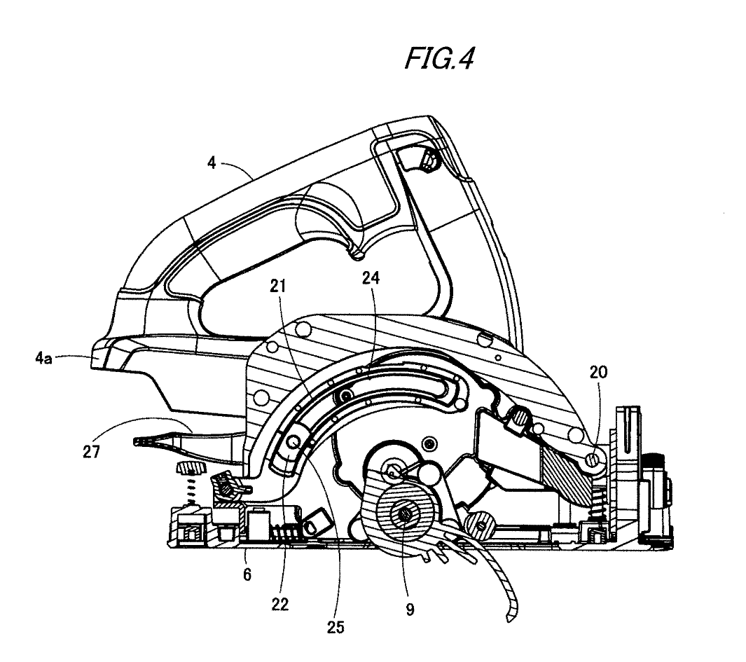

The surface plate 6 is a metallic plate-like member which is provided at the bottom of the cutting machine main body 3, and an opening portion 16 extends through a part of the surface plate 6. Below the opening portion 24, a part of the saw blade 1 is exposed. A front end portion of the surface plate 6 is rotatably supported by a pivot 20 (refer to FIG. 4) provided at the front portion of the cutting machine main body 3. The rotation shaft 9 of the saw blade 1 is located on one side (upper side) of the above surface plate 6. Namely, a part of the saw blade 1 passes through the opening portion 16 extending through the above surface plate 6, and is exposed to the other side (lower side) of the surface plate 6. The surface plate 6 is rotatably supported by the cutting machine main body 3. By changing an angle of the surface plate 6 with the above cutting machine main body 3, the projecting amount by which a part of the saw blade 1 projects from the other side of the surface plate 6 is changed. The saw blade 1 portion exposed to the other side (lower side) of the surface plate 6 is covered with an arc-like lower guard 17. This lower guide 17 is attached rotatably around the rotation shaft (final shaft) 9 of the saw blade 1.

The operation handle 4 is arranged on top of the cutting machine main body 3. A front portion of the operation hand 4 is integrally arranged slightly nearer the motor housing 13 side of the front portion of the cutting machine main body 3. A back portion of the operation handle 4 is crooked, and a crook end portion thereof is arranged integrally on a back surface of the cutting machine main body 3. Inside a front portion of a grip portion of the handle 4, a switch button 18 for the electric motor 2 is arranged as an operational part. Between the lower portion of the rear end 4a of the handle 4 and the surface plate 6, there is formed an attachment part for the battery pack 5 provided with a known attachment and detachment mechanism. The battery pack 5 can be inserted and attached from the back side of the attachment part by a known means, and locked. After lock release, the batter pack 5 can be pulled out and detached from the attachment part.

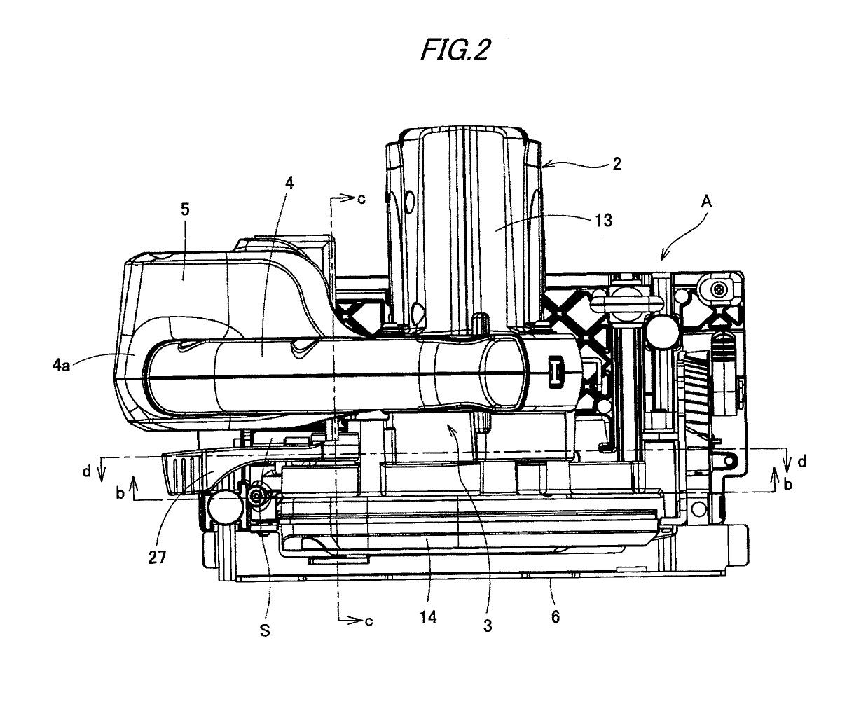

The above battery pack 5, as shown in FIG. 2, is arranged in the vicinity of the electric motor 2, off-set from the center in the right-left direction (up-down direction in FIG. 2) of the above handle 4 to the electric motor 2 side. Namely, the center of the battery pack 5 in the above first direction (direction parallel to the rotation shaft of the saw blade 1) is located closer to the electric motor 2 side than the center in the first direction of the above handle 4. Hereby, space S is formed between the saw blade 1 side of the battery pack 5 and the saw cover 14.

The above portable cutting machine is provided with the cutting-depth adjusting mechanism which adjusts a cutting-depth of a material to be cut by adjusting variably the projecting amount of the saw blade 1 from the undersurface of the surface plate 6. This cutting-depth adjusting mechanism includes the above space S and is arranged closer to the saw blade 1 side than to the battery pack 5.

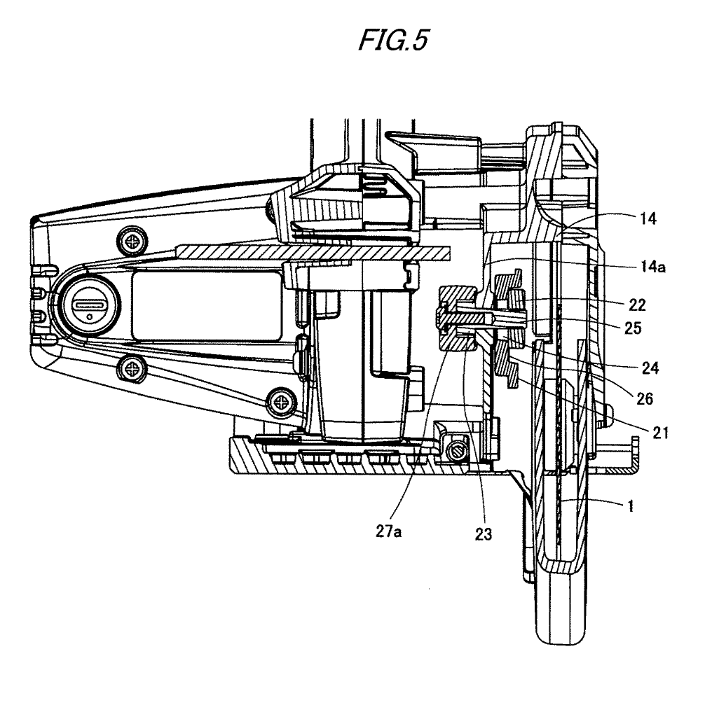

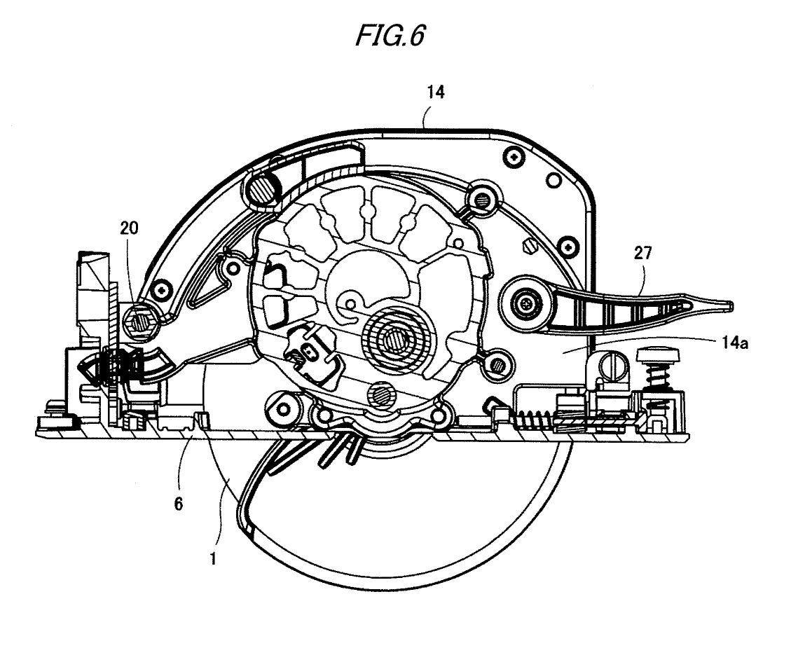

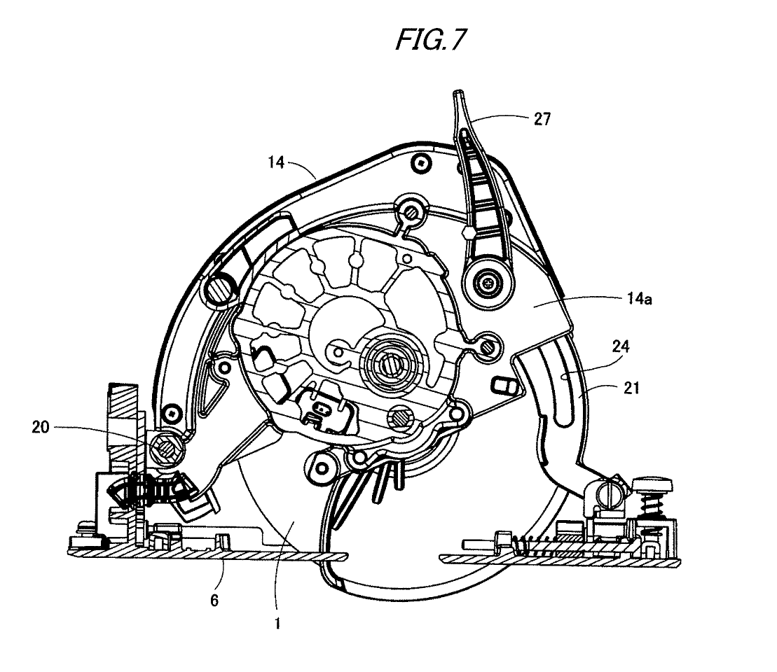

In the cutting-depth adjusting mechanism, as shown in FIG. 4, an arc-like link 21 is provided, extending from the back portion of the surface plate 6. This link 21 is, as shown in FIG. 5, held between a pair of holding bodies 22, 23 provided on the cutting machine main body 3. By loosening or tightening the holding bodies 22, 23 by means of an adjusting lever 27, the surface plate 6 is, as shown in FIGS. 6 and 7, rotated around the pivot 20 up to the desired position and fixed there, whereby the projecting amount of the saw blade 1 from the undersurface of the surface plate 6 can be adjusted. In this way, the cutting depth of the material to be cut is adjusted. Namely, the cutting-depth adjusting mechanism includes the link 21 which protrudes from the surface on one side of the surface plate 6, the holding bodies 22, 23 which are provided on the above cutting machine main body 3 and hold the link 21 between, and the adjusting lever 27 for changing a relative position between the holding bodies 22, 23 and the link 21. When the holding bodies 22, 23 are separated from the link 21 by the operation of the adjusting lever 27, the surface plate 6 becomes rotatable integrally with the link 21 in relation to the cutting machine main body 3, so that the projecting amount by which a part of the saw blade 1 projects from the other side of the surface plate 6 can be changed. When the holding bodies 22, 23 are engagedwiththe link 21 by the operation of the adjusting lever 27, the surface plate 6 becomes unrotatable integrally with the link 21 in relation to the cutting machine main body 3, so that the projecting amount by which a part of the saw blade 1 projects from the other side of the surface plate 6 can be fixed.

As shown in FIGS. 4 and 5, in the center of the link 21, a long hole 24 extending in the longitudinal direction of the link 24 is formed like an arc, and a shaft 25 provided on the cutting machine main body 3 side extends through the long hole 24. The shaft 25 further extends through a sidewall 14a inside the saw cover 14. To the shaft 25, the holding bodies 22, 23 which hold the link 21 between are attached from the inside and the outside. The outer holding body 22 is provided slidably along a recess groove 26 formed in the longitudinal direction of the link 21, and screwed to the shaft 25. The inner holding body 23 is formed integrally with the shaft 25, and with a base portion 27a of the adjusting lever 27. Hereby, as shown in FIGS. 6 and 7, by rotating the adjusting lever 27 in the down-direction and the up-direction, the outer holding body 22 can be brought close to or separated from the inner holding body 23 to loose or tighten the link 21 together with the side wall 14a, whereby the surface plate 6 is rotated around the pivot 20 and the projecting amount of the saw blade 1 can be adjusted.

According to the above mechanism, as shown in FIG. 7, by rotating the adjusting lever 27 to the upside, the holding bodies 22, 23 are loosened, whereby the rear portion of the surface plate 6 becomes free. Therefore, the surface plate 6 can rotate around the pivot 20 provided at the front portion of the cutting machine, and the projecting amount of the saw blade 1 which projects from the undersurface of the surface plate 6 changes depending on the rotation. Since the projecting amount represents a cutting depth, the cutting depth can be adjusted in response to the material to be cut. After the adjustment, the adjusting lever 27 is rotated in the opposite direction thereby to operate the holding bodies 22, 23 in the tightening direction, whereby the surface plate 6 and the cutting machine main body 3 can be fixed at the adjusted angle.

The above shaft 25 extends up to the front of the battery pack 5, and an end portion of the shaft 25 stops in the space S between the battery pack 5 and the saw cover 14. The adjusting lever 27 is arranged in the space S, and provided operatably in the turning form to the back of the saw caver 14.

As described above, since the battery pack 5 is arranged in the vicinity of the electric motor 2 and in the position off-set from the center of the handle 4 to the electric motor 2 side, the space S is formed between the saw cover 1 and the battery pack 5, and this space S can be utilized as space in which the cutting-depth adjusting mechanism is provided. Thus, structurally, the shaft 25 constituting the depth-adjusting mechanism does not extend through the cutting machine main body 3 in the right-left direction, but the end of the shaft 25 is provided on the saw blade 1 side of the battery pack 5. Accordingly, there is not any obstacle to arranging the battery pack close to the back portion of the electric motor 2. Therefore, it is possible to arrange the battery pack 5 in such a close position that the battery pack 5 can abut directly on the motor housing 13. Accordingly, since the battery pack 5, the electric motor 2, and the saw blade 1 are arranged in a concentrated manner, size reduction of the machine can be advanced more.

Not only the battery pack 5, the electric motor 2, and the saw blade 1 are arranged near the switch button 18 of the handle 4 in the concentrated manner, but also the battery pack 5 is provided near the electric motor 2 and in the position off-set from the center of the operation handle 4 to the electric motor 2 side. Hereby, when the operator holds the portable cutting machine in his hand, the portable cutting machine is good in right-left weight balance, and stable without tilting neither to the left nor to the right. Therefore, the portable cutting machine is good in handling and the operator is difficult to get tired even if he uses the portable cutting machine for a long time. Accordingly, it is possible to obtain a portable cutting machine which is good in weight balance, and greatly easy for handling.

Further, since the adjusting lever 27 is provided between the battery pack 5 and the saw blade 1 in the turning form to the back of the saw cover 14, operability of the adjusting lever 27 can be made good, and further an accident that the adjusting lever 27 bumps against other members during the cutting operation becomes difficult to occur. Therefore, malfunction of the cutting-depth adjusting mechanism is hardly produced, so that safety of the work is improved.

The cutting-depth adjusting mechanism, as long as the link 21 can be tightened and loosened, is not limited to the above-mentioned form. For example, the adjusting lever 27, instead of being provided integrally with the holding bodies 22, 23, may be provided integrally with the shaft thereby to rotate the shaft.

Further, also in case that the adjusting lever 27 is provided not between the battery pack 5 and the saw blade 1 but at the back portion of the saw cover 14, arrangements of the battery pack 5 and the handle 4 can be moved to the saw blade 1 side by the space of the adjusting lever 27.

Although the invention has been described in detail and with reference to the specific embodiment, various changes and modification may be made therein without departing from the spirit and scope of the invention.

### INDUSTRIAL APPLICABILITY

The present invention can be applied to a portable cutting machine having a circular saw.

### DESCRIPTION OF REFERENCE NUMERALS AND SIGNS

1 Saw blade

2 Electric motor

3 Cutting machine main body

4 Operation handle

5 Battery pack

6 Surface plate

14 Saw cover

27 Adjusting lever

1: A portable cutting machine comprising:
a cutting machine main body;
a saw blade provided rotatably with respect to the cutting machine main body;
an electric motor adapted to drive the saw blade;
a handle which is provided between the saw blade and the electric motor in a first direction parallel to a rotation shaft of the saw blade and extends in a second direction perpendicular to the first direction;
a battery pack adapted to drive the electric motor; and
a surface plate rotatably supported by the cutting machine main body,
wherein a center in the first direction of the battery pack is located closer to a side of the electric motor than a center in the first direction of the handle,
wherein the rotation shaft of the saw blade is located on one side of the surface plate,
wherein a part of the saw blade passes through an opening portion penetrating through the surface plate and is exposed to the other side of the surface plate,
wherein a projecting amount of the saw blade by which the part of the saw blade projects from the other side of the surface plate is changeable by changing an angle of the surface plate with respect to the cutting machine main body, and
wherein a cutting-depth adjusting mechanism adapted to change the angle of the surface plate with respect to the cutting machine main body is located, in the first direction, closer to a side of the saw blade than the battery pack.

2: The portable cutting machine according to claim 1, wherein the cutting-depth adjusting mechanism is located between the battery pack and the saw blade.

3: The portable cutting machine according to claim 1, wherein the cutting-depth adjusting mechanism includes:
a link which protrudes from a surface on said one side of the surface plate;
a holding body provided on the cutting machine main body; and
an adjusting lever adapted to change a relative position between the holding body and the link,
wherein in a condition that the holding body is separated from the link by an operation of the adjusting lever, the surface plate is rotatable with respect to the cutting machine main body integrally with the link and the projecting amount by which the part of the saw blade projects from the other side of the surface plate is changeable,
wherein, in a condition that the holding body is engaged with the link by an operation of the adjusting lever, the surface plate is unrotatable with respect to the cutting machine main body integrally with the link and the projecting amount by which the part of the saw blade projects from the other side of the surface plate is fixed.

4: The portable cutting machine according to claim 3, further comprising:
a saw cover which is fixed to the cutting machine main body and covers a portion of the saw blade located on said one side of the surface plate,
wherein the adjusting lever is arranged between the battery pack and the saw blade and has a shape turning to a backside of the saw cover.
